(19) United States
(12) Patent Application Publication
(10) Pub. No.: US 2005/0163172 A1
(43) Pub. Date: Jul. 28, 2005

(54) High-power laser diode arrangement with external resonator

(76) Inventors: Joachim Sacher, Marburg (DE); Sandra Stry, Fronhausen (DE)

Correspondence Address: KLAUS J. BACH & ASSOCIATES, 4407 TWIN OAKS DRIVE, MURRYSVILLE, PA, 15668, US

(21) Appl. No.: 10/784,030

(22) Filed: Feb. 20, 2004

(30) Foreign Application Priority Data
Jan. 27, 2004 (DE) 2004 001 230.8

(51) Int. Cl. H01S 3/10

(52) U.S. Cl. 372/20; 372/92; 372/97

(57) ABSTRACT

In a laser diode arrangement for generating single mode laser radiation including a broad area laser diode having a rear facet and a front facet and forming a first resonator and an external second resonator, which is coupled to the first resonator by way of an optical transmission component and a wave-length selective optical reflection element, such that the laser light emitted from the broad area laser diode is coupled back into the first resonator, the optical transmission component is a rotational symmetrical collimator lens which is so arranged and oriented that the laser light emitted from the broad area laser diode is collimated in a spatial direction normal to the epitaxial plane of the laser diode.

### BACKGROUND OF THE INVENTION

The invention relates to a high power laser diode arrangement with an external resonator for generating single-mode tunable laser radiation.

With a semiconductor laser diode operated in the flow direction coherent laser light can be generated by stimulated emission. In order to be able to change the frequency or, respectively, the wavelength, the semiconductor laser diode is combined with an external resonator which couples only light of certain wavelengths—the resonator modes—back into the laser diode by way of wavelength selective elements such as grids and filters. This results in an amplification of the stimulated emission having the respective selected wavelength (single-mode operation). At the same time, the emission wavelength can be tuned by the wavelength selective element over the amplification range of the laser diode.

Such a single-mode operation can usually easily and reliably realized with single-area diode lasers, because their optical active zone (emitter) has a cross-sectional area which is limited to about 1 μm×3 μm. At the same time, the obtainable output power is limited maximally to 200 to 300 mW, which is insufficient for many applications.

For increasing the output power, it is known therefore to increase the width of the emitter up to 600 μm. The power output of these so-called broad-area lasers (high-power lasers) can be increased in this way to more than 10 W. It is however a disadvantage that the laser diode is excited in lateral direction, that is parallel to the epitaxial plane, in multiple modes, so that an increase in the power output results in a highly incoherent light emission. Normal to the epitaxial plane, that is, in a transverse direction thereto, the laser diode has an infraction-limited beam quality.

In order to overcome this, S. Wolff et al. in “INTRACAVITY STABILIZATION OF BROAD AREA LASERS BY STRUCTURED DELAYED OPTICAL FEEDBACK”, (OPTIC EXPRESS, Vol. 7, No. 6, 11.09, 2000) use for the stabilization of the light emission of a broad-area laser a miniaturized external resonator with a convex mirror which couples only axis-parallel radiation back into the active zone of the laser. The mirror—a silver-coated glass rod—is disposed only a few millimeters away from the front facet of the laser diode which is provided with an anti-reflection layer. The rear facet is coated with a highly reflective coating. The emitter layer has a cross-sectional area of 1 μm×100 μm. A micro-cylinder lens arranged between the front facet and the convex mirror serves as collimator. It is disadvantageous in this connection that such an arrangement is not tunable in spite of an expensive optical system.

WO 03/055018 discloses an apparatus for generating laser radiation with an edge-emitting broad area laser in an external instable resonator. The latter includes a reflective element which has no influence on the divergence of the light exiting the semiconductor and is arranged in such a distance from the semiconductor that the divergent light exiting the semiconductor is partially reflected to the semiconductor. From this partially reflected laser light, only a part is coupled into the semiconductor chip by way of an entrance/exit opening so t h a t the efficiency is relatively low. In addition, this arrangement requires additional optical components. Therefore a cylinder lens with a short focus is for example arranged between the semiconductor laser and the reflective element in order to reduce the high divergence normal to the epitaxial plane which is typical for broad area laser diodes.

To improve the beam quality of broad area lasers therefore complicated and expensive optical systems are required. In addition, such resonator arrangements are usable in rough industrial environments or in space only in a limited way because the numerous optical elements are sensitive to vibration and to temperature changes. The resonator is de-adjusted thereby and re-adjusting is not always possible.

In the single area diode laser field resonators are already known, which are adjustment insensitive. EP A 20 347213, for example, proposes a laser diode system with an external resonator in a Littrow arrangement which, in addition to an optical collimation system and an inflection grid, includes an anamorphic transmission range which forms the laser beam in such a way that it reaches the infraction grid in a line focus. To this end, a cylindrical collector lens is arranged behind the collimator lens whose optical axis extends normal to the grid lines of the resonator grid. Additional prisms are provided to widen the beam in order to further increase the beam width.

Such an arrangement however also needs a plurality of optical elements and as a result is relatively large. A miniaturization of the arrangement is hardly possible because of quality problems in the manufacture of short-focus cylinder lenses. In addition, such an arrangement cannot simply be transferred to broad area lasers.

It is the object of the present invention to overcome these and other disadvantages of the state of the art and to provide a laser diode arrangement with a broad area laser diode and an external resonator, which has a high power yield and, at the same time, a high beam quality. It is particularly desirable for such a laser arrangement to generate single mode laser light whose wavelengths is continually tunable without any mode hops. It should further be simple in its design, inexpensive to manufacture and easy to handle. The focusing properties of the external resonator should be adjustment insensitive.

### SUMMARY OF THE INVENTION

In a laser diode arrangement for generating single mode laser radiation including a broad area laser diode having a rear facet and a front facet and forming a first resonator and an external second resonator which is coupled to the first resonator by way of an optical transmission component and a wave-length selective optical reflection element such that the laser light emitted from the broad area laser diode is coupled back into the first resonator, the optical transmission component is a rotational symmetrical collimator lens which is so arranged and oriented that the laser light emitted from the broad area laser diode is collimated in a spatial direction normal to the epitaxial plane of the laser diode.

Because of the geometry of the emitter, the broad area laser diodes have, in a transverse direction, that is, in a direction normal to the epitaxial plane, a laser emission angle of about 30° and in a lateral direction, that is in a direction parallel to the epitaxial plane, an emission angle of about 5°. It has surprisingly been found that, with the use of a simple rotation-symmetrical collimator lens in combination with a broad area laser diode, in a spatial direction parallel to the epitaxial plane, at a well-defined distance from the front facet of the laser diode a line focus is generated on the wave-length selective optical reflection element. As a result, the resonator is adjustment insensitive with respect to the rotation of the wavelength selective reflection element with an axis of rotation normal to the epitaxial plane of the laser diodes. A rotation of the wavelength selective reflection element about an axis parallel to the epitaxial plane however results in the tuning of the emission wave-length.

The whole laser arrangement can be built so as to be very compact and sturdy, that is, it easily withstands mechanical shocks and vibrations. It may even be used in rough industrial environments and in space. The light coupled back from the wavelength selective element is always focused exactly onto the light emitting laser facet so that neither mode hops nor power losses occur. Expensive compensation structures are not required. The efficiency is relatively high.

Because the line focus is generated exclusively by imaging the laser diode facet by way of the rotation-symmetrical collimator lens, which is preferably an aspheric lens, additional optical components such as a cylinder lens are not required. It is therefore possible to generate single-mode mode hop free tunable laser radiation of high power in a simple and inexpensive way.

In this regard, it is also advantageous if the wave-length selective optical reflective element is arranged in the area of the Raleigh-length of the focus of the optical transmission component. In this way, the optical resonator is always stable.

The power output can be further increased if the laser radiation is uncoupled by way of the rear facet of the broad area laser diode and the ratio of the reflectivity of the rear facet to the reflectivity of the optical reflection element is much smaller than 1. In this way, variations in the light output and mode hops in the spectral tuning curve of the laser system can be effectively avoided. Also, the ratio of the reflectivity of the rear facet and of the reflectivity of the optical reflection element should be smaller than 0.1. Preferably, the reflectivity of the optical reflection element is at least 95%. These values can be realized in a simple and inexpensive way.

In the area of the rear facet of the broad area laser diode, preferably an additional optical transmission component is arranged which expediently includes a collimator lens. In addition, a cylinder lens may be provided so that the output beam of the laser diode arrangement can be shaped in accordance with the respective requirements.

For an optical coupling of the external resonator to the resonator formed by the laser diode, the front facet of the broad area laser diode is provided with an antireflection coating providing for a reflectivity of less than 0.1%.

The wavelength selective reflection element is preferably an optical infraction grid and or a mirror. Accordingly, the broad area laser electrode and the external resonator form a Littman- or a Littrow arrangement.

In a preferred embodiment of the invention, the broad area laser diode includes an active zone, which includes parallel to the epitaxial plane a rectangular shape. The cross-sectional area of this active zone has, normal to the epitaxial plane, a width of between 5 μm and 600 μm.

Alternatively, the broad area laser diode may include an active zone which has a trapezoidal shape parallel to the epitaxial plane. This prevents the excitation of spatial vibration modes, whereby the radiation quality is further improved. The cross-sectional area of the active zone has, at the front facet normal to the axial plane, a width of 5 μm to 300 μm so that high power yields can be achieved also in this case.

A further power increase is achieved if the broad area laser diode is formed by a laser diode array.

Further features and advantages of the invention will become more readily apparent from the following description of embodiments thereof on the basis of the accompanying drawings.

### BRIEF DESCRIPTION OF THE DRAWINGS

FIG. 1 is a schematic top view of a laser diode arrangement in a Littman configuration,

FIG. 2 shows the laser diode arrangement according to FIG. 1 in a side view,

FIG. 3 is a schematic top view of a laser diode arrangement in Littrow configuration and,

FIG. 4 shows the laser diode arrangement of FIG. 3 in a side view.

### DESCRIPTION OF PREFERRED EMBODIMENTS

The laser diode arrangement designated in FIG. 1 generally by the reference numeral 10 for generating single-mode tunable laser radiation 15 is in a Littman configuration. It comprises a broad area laser diode 11, which is mounted on a carrier 12, for example, a base plate or a mounting block. The rear facet 16 and the front facet 17 of the laser diode 11 form the end areas of a first resonator R1, whose length is determined by the length of the semiconductor crystal of the broad laser diode 16. The front facet 17 is provided with an anti-reflection coating of a reflectivity of less than 0.1% for an improved coupling of the external resonator R2 to the first resonator R1.

The broad area laser diode 11 has an active zone Z which has a rectangular shape parallel to the epitaxial plane E. The cross-sectional area of the active zone Z normal to the epitaxial plane E has a height of 1 μm and a width B of 500 μm so that the laser diode 11 can reach a power output of over 10 W.

The laser light 13 emitted from the laser facet 17 is focused by an optical transmission component 30 in the form of a rotation-symmetrical aspheric collimator lens onto the surface of an optical inflection grid 40 which forms a wavelength selective reflection element and, together with a mirror 50, is part of an external resonator R2. The reflectivity of the planar grid 40 is preferably about 95% so that a large part of the laser light 14 of the first inflection order is directed by the grid 40 onto the mirror 50. From there, the light is reflected back and, after being inflected a second time by the grid 40, is coupled back into the broad area laser diode 11.

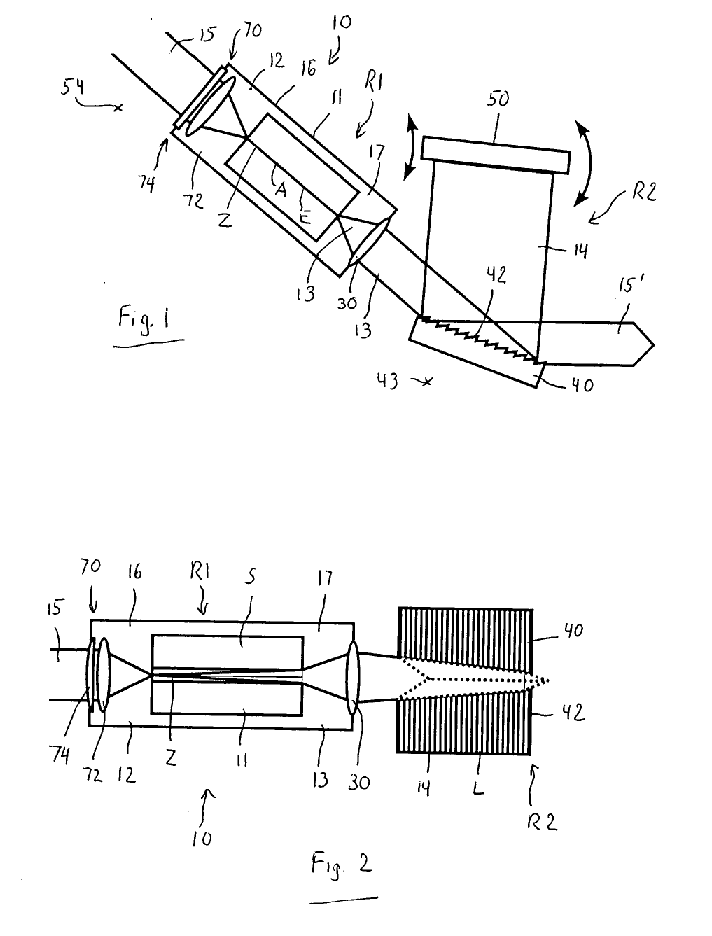

As shown in FIG. 2, the rotation symmetrical aspheric collimation lens 30 is so arranged or, respectively, oriented that the laser light 13 emitted from the broad area laser diode 11 is collimated in a spatial direction S normal to the epitaxial plane E of the laser diode 11. As a result, a line focus L is generated on the optical infraction grid 40 normal to the grid lines 42, that is, the laser light 13 emitted from the laser facet 17 is depicted by the transmission component 30 on the grid 40 as a narrow line L whose height is much smaller than its width.

With this simple arrangement, which is also relatively inexpensive, the laser arrangement 10 altogether becomes adjustment insensitive with respect to tilting of the grid 40 about an axis normal to the grid lines 42, which might occur during pivoting of the grid 40 about the axis 43 or by vibrations. In addition, no power losses occur caused by the resonator optical system because the imaging properties of the highly compact resonators R2 are always optimal. As a result, the timing behavior of the laser arrangement 10 during pivoting of the grid 40 about the axis 43 remains unchanged. The power output of the broad area laser 11 is always optimal and the efficiency of the laser arrangement 10 is very high.

In order to obtain a stable external resonator R2, the grid 40 is arranged in the area of the Raleigh length of the focus of the rotation-symmetrical aspheric collimator lens 30. It is preferably disposed on a carrier (not shown) which can be pivoted about at least an axis normal to the grid lines 42 and/or linearly moved in various directions by adjustment means for example by a slide table. The grid lines 42 of the grid 40 extend herein normal to the longitudinal axis A of the broad area laser diode 11.

The mirror 50 is mounted on a support arm (not shown), which is supported so as to be pivotable about an axis 54. The axis 54 extends parallel to the mirror plane. If the support arm is pivoted about the axis 54, the wavelength coupled by the grid 40 back into the laser diode 11 changes. The laser 10 becomes detuned. At the same time, the length of the wave-length determined by the length of the external resonator R2 changes, whereby, in accordance with DE U1 296 06 494, a mode hop-free wavelength tuning is made possible.

The laser radiation 15 is preferably uncoupled by way of the rear facet 16 of the broad area laser diode 11, which therefore has a reflectivity of not more than 1%, that is, the ratio of the reflectivity of the rear facet 16 to the reflectivity of the optical grid 40 is much smaller than 1, preferably much smaller than 0.1. In this way, the power output of the laser is further increased because substantially more light is coupled back from the external resonator R2 into the broad area laser diode 11.

For a certain utilization of the laser radiation 15 emitted from the laser diode arrangement 10, an optical transmission component 70 in the form of a collimator lens 72 and a cylinder lens 74 is arranged at the rear facet 16.

In this way, the laser beam 15 can be formed as it is suitable for the certain application.

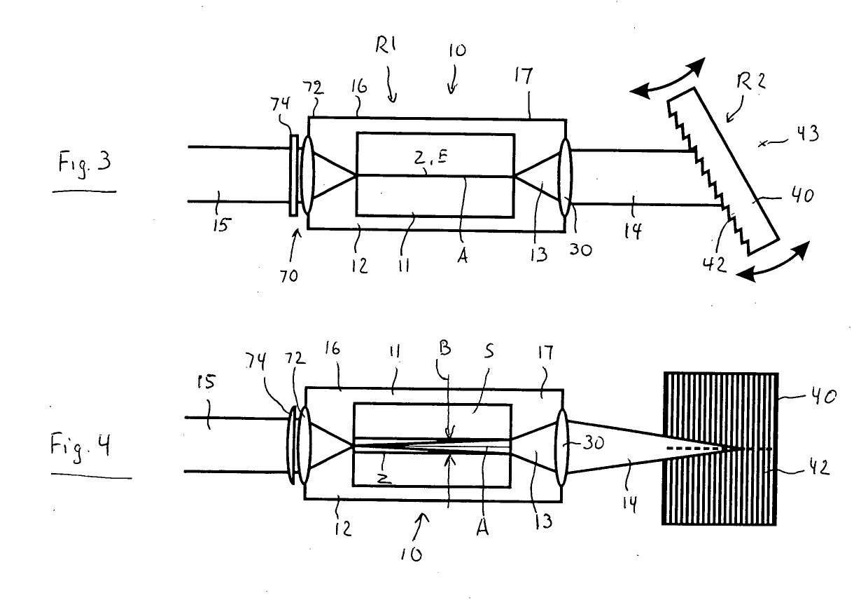

In the embodiment of FIGS. 3 and 4, the laser diode arrangement 10 has a Littrow configuration. If consists essentially of a broad area laser diode 11 and the external resonator R2, which is formed by the optical transmission component 30, which is a rotation symmetrical aspheric collimator lens, and the wavelength selective optical reflection element 40, which is a resonator end mirror including a planar infraction grid. The laser light 15 is uncoupled also in this case by way of the rear facet 16 of the broad area laser diode 11.

However, the invention is not limited to a particular described embodiment but may be varied in various ways.

For example, the broad area laser diode 11 may include an active zone Z, which has a trapezoidal shape parallel to the epitaxial plane E, wherein the cross-sectional area of the active zone Z at the front facet 17 normal to the epitaxial plane E has a width B of 5 μm to 300 μm. In this way, the excitation of spatial modes can be avoided even with a relatively high power output.

The power output can be further increased if the broad area laser diode 11 is formed by a laser diode arrangement, or respectively, block.

In another embodiment, the laser light 15 may be uncoupled by way of the grid 40. In this case, the rear facet of the broad area laser diode 11 has a reflectivity of about 95% and the grid has a reflectivity of about 5%.

1. A laser diode arrangement (10) for generating single mode tunable laser radiation (15) comprising a broad area laser diode (11) having a rear facet (16) and a front facet (17) and forming a first resonator (R1), an external, second resonator (R2) coupled to said first resonator (R1), an optical transmission component (30) and at least one wavelength selective optical reflection element (40, 50) for coupling laser light (13) emitted from the broad area laser diode (11) back into the first resonator (R1), said optical transmission component (30) being a rotational symmetrical collimator lens which is so arranged and oriented that the laser light (13) emitted from the broad area laser diode (11) is collimated in a spatial direction (S) normal to the epitaxial plane E of the laser diode.

2. An arrangement according to claim 1, wherein said optical transmission component (30) is an aspheric lens.

3. An arrangement according to claim 1, wherein said wave-length selective reflection element (40, 50) is arranged in the area of the Raleigh length of the focus of the optical transmission component (30).

4. An arrangement according to claim 1, wherein the laser radiation (15) is uncoupled by way of the rear facet (16) of the broad area laser diode (11), the ratio of the reflectivity of the rear facet (16) and the reflectivity of the optical reflection element (40) being smaller than 1.

5. An arrangement according to claim 4, wherein the ratio of the reflectivity of the rear facet (16) and the reflectivity of the optical reflection element 40 is smaller than 0.1.

6. An arrangement according to claim 4, wherein the reflectivity of the rear facet (16) is at most 1% and the reflectivity of the optical reflection element (40) is at least 95%.

7. An arrangement according to claim 4, wherein, in the area of the rear facet (16), the broad area laser diode (11) includes an additional optical transmission component (70).

8. An arrangement according to claim 7, wherein said additional optical transmission component (70) comprises a collimator lens (72).

9. An arrangement according to claim 7, wherein the additional optical transmission component (70) includes a cylinder lens (74).

10. An arrangement according to claim 1, wherein the front facet (17) of the broad area laser diode (11) facing the external resonator (R2) is provided with an antireflection coating.

11. An arrangement according to claim 10, wherein the reflectivity of the antireflection-coated front facet (17) is less than 0.1%.

12. An arrangement according to claim 1, wherein the wave-length selective reflection element (40) is an optical infraction grid (40).

13. An arrangement according to claim 1, wherein the wave-length selective reflection element (50) is a mirror.

14. An arrangement according to claim 1, wherein the broad area laser diode (11) and the external resonator (R2) form one of a Littman and a Littrow arrangement.

15. An arrangement according to claim 1, wherein said broad area laser diode (11) has an active zone (Z) has, parallel to the epitaxial plane E, a rectangular shape.

16. An arrangement according to claim 15, wherein the cross-sectional area of the active zone (Z) normal to the epitaxial plane (E) has a width of between 5 μm and 600 μm.

17. An arrangement according to claim 1, wherein the broad area laser diode (11) has an active zone (Z) which, parallel to the epitaxial plane (E) has a trapezoidal shape.

18. An arrangement according to claim 17, wherein the cross-sectional area of the active zone (Z) has, at the front facet (17) normal to the epitaxial plane E, a width between 5 μm and 300 μm.

19. An arrangement according to claim 1, wherein the broad area laser diode (11) is formed by a laser diode array.
